(19) United States
(12) Patent Application Publication
(10) Pub. No.: US 2017/0091316 A1
(43) Pub. Date: Mar. 30, 2017

(54) ELECTRONIC DEVICE AND CONTROLLING METHOD THEREOF

(71) Applicant: SAMSUNG ELECTRONICS CO., LTD., Suwon-si (KR)

(72) Inventor: Seon-ho HWANG, Yongin (KR)

(73) Assignee: SAMSUNG ELECTRONICS CO., LTD., Suwon-si (KR)

(21) Appl. No.: 15/193,982

(22) Filed: Jun. 27, 2016

(30) Foreign Application Priority Data
Sep. 25, 2015 (KR) 10-2015-0136714

(51) Int. Cl. G06F 17/30

(52) U.S. Cl. CPC G06F 17/30675; G06F 17/30864

(57) ABSTRACT

An electronic device and a controlling method thereof are provided. The controlling method of the electronic device includes acquiring an image, extracting a search formula from the acquired image, generating a search result based on the extracted search formula, and outputting the generated search result.

### CROSS-REFERENCE TO RELATED APPLICATION

This application claims priority benefit from Korean Patent Application No. 10-2015-0136714, filed in the Korean Intellectual Property Office on Sep. 25, 2015, the disclosure of which is incorporated herein by reference.

### BACKGROUND

1. Field

Aspects of the exemplary embodiments relate to an electronic device and a controlling method thereof, and more specifically, to an electronic device which can search offline information online and provide a searched result and a controlling method thereof.

2. Description of the Related Art

Recently, amount of information provided online is increasing thanks to developments of electronic devices and the Internet. However, various kinds of information such as a book, newspaper and a report are still provided offline and much information among previously generated information is stored offline.

While approaching information offline, if receives information for which a search is needed, most of people search the information by using online database. There exists an inconvenience of inputting a search phrase in an Internet web-page in order to search the online database while approaching the offline information.

Also, if a user only searches for an unknown word, similar words are also searched together and a user's intended search is not well carried out. Therefore, there exists an exists an inconvenience that the user has to do an additional search.

Therefore, a necessity of an intuitive information search method by which off-line information can be searched for online is on the rise.

### SUMMARY

An aspect of the exemplary embodiments relates to a method of searching for offline information online.

According to an exemplary embodiment, there is provided a controlling method of an electronic device including acquiring an image, extracting a search formula from the acquired image, generating a search result based on the extracted search formula and outputting the generated search result.

The search formula may include at least one of a search domain, a search command and a search result outputting device.

The extracting a search formula may include recognizing a search identifier included in the acquired image and extracting a search formula corresponding to the recognized search identifier.

The search identifier may include at least one of an underline and a shade setting.

The search domain may include designating an Internet web-page or a search server to search a search word.

The generating the search result may include generating a search result based on context of a sentence that includes the search word.

The extracting a search formula may include recognizing a character included in the image by using an optical character reader and extracting a search formula which is input by a user by using intelligent character recognition.

The outputting may include transmitting the search result to at least one of a printer, a display device and a predesignated Internet address.

According to an exemplary embodiment, an electronic device includes an image acquiring unit, an output unit and a controller configured to control the image acquiring unit to acquire an image and control the output unit in order to extract a search formula from the acquired image, generate a search result by using the extracted search formula and output the generated search result.

The search formula may include at least one of a search domain, a search command and a search result outputting device.

The controller may include recognizing a search identifier included in the acquired image and extracting a search formula corresponding to the recognized search identifier.

The search identifier may include at least one of an underline and a shade setting.

The search domain may include designating an Internet web-page or a search server to search a search word.

The controller may generate the search result based on context of a sentence that includes the search word.

The controller may include recognizing a character included in the image by using an optical character reader and extracting a search formula which is input by a user by using intelligent character recognition.

A communicator configured to communicate with an external device may be included and the controller may include controlling the communicator to transmit the search result to at least one of a printer, a display device and a predesignated Internet address.

As described above, according to various exemplary embodiments, there is provided an electronic device providing more intuitively searched information to a user by being connected online.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings.

FIG. 1 is a block diagram illustrating a configuration of an electronic device according to an exemplary embodiment.

FIG. 2 is a block diagram illustrating a configuration of an electronic device according to an exemplary embodiment.

FIGS. 3, 4A-4D, 5A-5B, 6, and 7A-7B are views illustrating various exemplary embodiments providing a result searched according to a search formula according to various exemplary embodiments.

FIGS. 8 and 9 are flowcharts illustrating a controlling method of an electronic device according to various exemplary embodiments.

### DESCRIPTION OF THE PREFERRED EMBODIMENTS

Terms used in the exemplary embodiments are briefly explained and the exemplary embodiments are described in detail.

Even though generally used terms which are used as broad as possible for the present are selected in consideration of functions described in the disclosure, the terms can vary according to an intention of a user who works in the art to which the present disclosure pertains, a precedent(s), or an appearance of new technology. Also, in a special case, there is a term(s) that the applicant discretionally selected and the term(s)'s meaning is explained in detail in a relevant part of the exemplary embodiments. Therefore, terms used in the exemplary embodiments should be defined based on meanings of the terms and the overall contents of the exemplary embodiments.

Expressions including ordinal numbers such as “first”, “second”, and so on as used herein may be used for describing a variety of elements, but the elements should not be limited by such expressions. The expressions mentioned above are used with a sole purpose of distinguishing one element from another. For example, without departing from the scope of the present disclosure, a “first element” may be named a “second element”, or similarly, the “second element” may be named the “first element.” A term “and/or” includes a combination of a plurality of related and described items or one item between or among a plurality of related and described items.

In the exemplary embodiments, a singular expression used herein includes a plural expression, unless specified otherwise in the context.

Terms “include” and “have” in the exemplary embodiments are to designate an existence of a feature, a number, a stage, an operation, a constituent element, a component described in the specification or a combination of thereof. The terms should not be understood to previously exclude a further existence of a feature, a number, a stage, an operation, a constituent element, a component or more than one different from the feature, the number, the stage, the operation, the constituent element or the component, or an additional possibility.

In exemplary embodiments, “a module” or “a unit” operates at least one function or operation and can be embodied as hardware, software or a combination of hardware and software. A plurality of “modules” or “units” can be embodied as at least one of processor by being integrated in at least one module except for “a module” or “a unit” which needs to be embodied as certain hardware.

In the exemplary embodiments, when it is described that a part is “connected” to another part, in addition to a case where the part “is directly connected” to another part, it includes a case where the part “is electronically connected” to another part while having other element(s) therebetween.

In the exemplary embodiments, a user input may include at least one among a touch input, a bending input, a voice input, a button input and a multimodal input but the user input is not limited thereto.

In exemplary embodiments, “an application” indicates a series of computer program group devised to perform a certain task. In exemplary embodiments, applications may vary. For example, there can be a game application, a video playing application, a map application, a memo application, a calendar application, a phone book application, a broadcasting application, an exercise supporting application, a payment application, a photo folder application, and etc but an application is not limited thereto.

Terms used in the specification including technical or science terms, if not differently defined, have meanings that people having ordinary skill in the art to which the present disclose pertains (hereinafter referred to as “those skilled in the art”) understand. Terms that are defined in a generally used dictionary should be interpreted as having meanings which are identical to meanings in context of technology related to the present disclosure, and if the terms are not clearly defined in the present disclosure, the terms should be not interpreted as ideal meanings or excessively formal meanings.

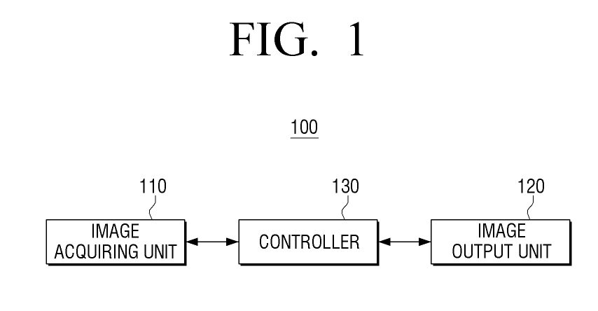

Hereinafter, the exemplary embodiments are described with reference to drawings. FIG. 1 is a block diagram illustrating a configuration of an electronic device according to an exemplary embodiment. As illustrated in FIG. 1, an electronic device 100 includes an image acquiring unit 110, an image output unit 120 and a controller 130. The electronic device 100 according to an exemplary embodiment may be embodied as various electronic devices such as a tablet PC, a laptop, a desktop PC and a smartphone.

The image acquiring unit 110 is configured to acquire an image. According to an exemplary embodiment, the image acquiring unit 110 may acquire an image including a search formula. The image acquiring unit 110 may be embodied as a scanner or a camera.

The image output unit 120 may output an image data. According to an exemplary embodiment, the image output unit 120 may output a search result which is generated by using a search formula.

The controller 130 may control overall operations of the electronic device 100. According to an exemplary embodiment, the controller 130 may extract a search formula from an acquired image from the image acquiring unit 110 and generate a search result by using an extracted search formula. The controller 130 may control an image output unit 120 to output a generated search result.

According to an exemplary embodiment, the controller 130 may control the image acquiring unit 110 to acquire an image. Herein, the image may be an image including a search formula.

The controller 130 may extract a search formula from the acquired image. According to an exemplary embodiment, a character included in the acquired image can be recognized by using at least one of an optical character reader (OCR) and intelligent character recognition (ICR). The OCR is usually used to recognize a character of a printed document and the ICR is usually used to recognize a character which is written by a user. However, the OCR and the ICR are not limited to the above-described functions.

If a character is recognized by using at least one of the OCR and the ICR, the controller 130 may recognize a search identifier included in the acquired image. The controller 130 may recognize an underline underlined on a character(s) or a shade set on a character(s) as a search identifier. In addition, the controller 130 may extract a search formula corresponding to the recognized search identifier.

In a search formula, information of at least one of a search domain, a search command and a search result outputting device may be included, and if a plurality of pieces of information about a search domain, a search command and a search result outputting device are included, the plurality of pieces of information may be listed by being classified by “,” or “:” Herein, the search domain may indicate an Internet web-page or a search server to search a search word, the search command may indicate a performing a search and the search result outputting device may indicate a device to output a search result.

The controller 130 may generate a search result by using an extracted search formula. For example, if an image where “www:?:display1” is written under a word “meme” where a shade is set is acquired through the image acquiring unit 110, the controller 130 may recognize the shade setting as a search identifier. The controller 130 may extract “www:?:display1” corresponding to the search identifier as a search formula.

Herein, “www” indicates a search domain, and for example, it may indicate to perform a search on an Internet web-page. “?” indicates a search command and for example, it may indicate to perform a search. “Display1” indicates a search result outputting device and for example, it may indicate to output a search result through an external Display1. Therefore, the controller 130 may search for “meme” on an Internet web-page based on an extracted search formula and output a result by using external device “Display1”

If results of a search performance based on a search formula are plural, the controller 130 may generate a search result based on a sentence or a word included in an acquired image. According to an exemplary embodiment, the controller 130 may generate a search result based on context of a sentence including the search word or generate a search result based on context of a previous sentence or a following sentence of a sentence including the search word.

The controller 130 may control the image output unit 120 to output a search result. If a search result is output through an electronic device, the controller 130 may control the image output unit 120 to output the search result but it only pertains to an exemplary embodiment, and if the search result is output through an external device, the controller 130 may control a communicator to transmit the search result. The controller 130 may send the search result in an e-mail or post on a pre-set web-page.

The electronic device 100 may provide a user with a function to search online with an offline data.

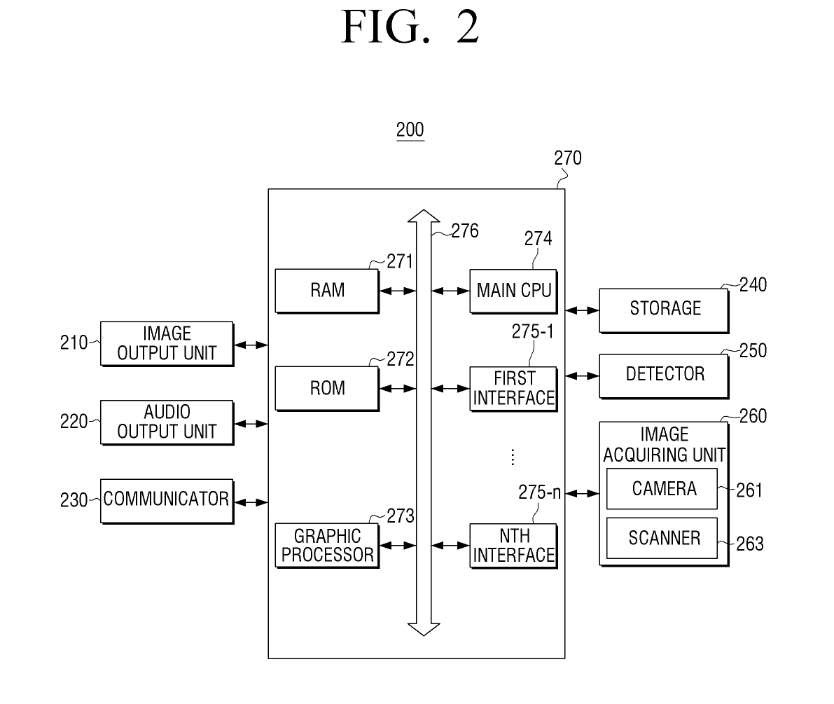

Hereinafter, various exemplary embodiments are described in detail with reference to FIGS. 2, 4A-4D, 5A-5B, 6, and 7A-7B. FIG. 2 is a block diagram illustrating a configuration of an electronic device 200 according to an exemplary embodiment. As illustrated in FIG. 2, the electronic device 200 includes an image output unit 210, an audio output unit 220, a communicator 230, a storage 240, a detector 250, an image acquiring unit 260 and a controller 270.

FIG. 2 illustrates an example of a case where the electronic device 100 includes various functions such as an input function, a transceiving function and a display function, and various constituent elements are overall illustrated. Therefore, according to an exemplary embodiment, some constituent elements illustrated in FIG. 2 may be omitted or changed, and another constituent element(s) may be further added.

The image output unit 210 outputs at least one of a video frame where a video data received from an image receiver (not illustrated) is processed in an image processor (not illustrated) and various screens generated in a graphic processor 273. According to an exemplary embodiment, the image output unit 210 may output a search result.

The audio output unit 220 is a configuration to output not only various audio data for which various processing operations are performed such as a decoding, amplification, a noise filtering by an audio processor (not illustrated) but also various alarming sounds or a voice message. According to an exemplary embodiment, the audio output unit 220 may be embodied as a speaker, or for example, as an output terminal which can output an audio data.

The communicator 230 is a configuration which performs communication with various kinds of external devices according to various kinds of communication system. The controller 230 may include various communication chips such as a W-Fi chip, a Bluetooth chip, a near-field communication (NFC) chip and a wireless communication chip. The Wi-Fi chip, the Bluetooth chip and the NFC chip respectively perform communications in Wi-Fi system, Bluetooth system and NFC system. Among these, the NFC chip indicates a chip that operates in NFC system which uses the 13.56 MHz band among various RF-ID frequency bands such as 135 kHz, 13.56 MHz, 433 MHz, 860-960 MHz, 2.45 GHz. In a case of using the Wi-Fi chip or the Bluetooth chip, various pieces of connection information such as SSID and session key may be first transceived and after communications is connected by these pieces of information, various pieces of information may be transceived. The wireless communication chip indicates a chip which performs communications according to various communication standards such as IEEE, ZigBee, 3rd Generation (3G), 3rd Generation Partnership Project (3GPP) and Long Term Evolution (LTE).

According to an exemplary embodiment, the communicator 230 may transmit a search result to an external device. The communicator 230 may transmit a search result to an external device by a local area network with the adjacent external device.

The storage 240 stores various modules to operate the electronic device 200. For example, in the storage 240, software including a base module, a sensing module, a communication module, a presentation module, a web-browser module and a service module can be stored. Herein, the base module is a base module which processes a signal delivered from respective hardware included in the electronic device 200 and delivers to an upper layer module. The sensing module, as a module that collects information from various sensors and analyzes and manages the collected information, may include a face recognition module, a voice recognition module, a motion recognition module and an NFC recognition module. The presentation module, as a module to constitute a display screen, may include a multimedia module to display and output multimedia contents and an UI rendering module which performs processing an UI and a graphic process. The communication module is a module for performing a communication with an external device or user. The web-browser module is a module that accesses a web server by performing a web browsing. The service module is a module that includes various applications to provide various services.

The storage 240 may include various program modules but various program modules may be omitted or changed in some parts according to a kind or a feature of the electronic device 200, or a part(s) of program module may be further added. For example, if the electronic device 200 is embodied in a tablet PC, a location determination module to determine a location based on PGS may be added to a base module, and a sensing module to detect a user's movement may be added to the sensing module.

In an exemplary embodiment, the storage 240 may include a memory card (not illustrated) (for example, a micro SD card, a memory stick) which is installed in a ROM 272, a RAM 271 or the electronic device 200 in the controller 270.

The detector 250 detects a surrounding environment of the electronic device 200. According to an exemplary embodiment, the detector 250 may include various sensors such as a GPS sensor which can detect location information, a movement detecting sensor which can detect a movement of the electronic device 200 (for example, a gyro sensor and an acceleration sensor), a pressure sensor and a noise sensor.

The image acquiring unit 260 acquires an image which includes a search formula. According to an exemplary embodiment, as illustrated in FIG. 2, the image acquiring unit 260 includes a camera 261 and a scanner 263. The image acquiring unit 260 may include various devices which can acquire an image except for the camera 261 and the scanner 263.

The controller 270 controls, for example, overall operations of the electronic device 200 by using various programs stored in the storage 240.

The controller 270, as illustrated in FIG. 2, includes processors including hardware processors, for example, the RAM 271, the ROM 272, the graphic processor 273, a main CPU 274, a first to nth interface 275-1 to 275-n and a bus 276. Herein, the RAM 271, the ROM 272, the graphic processor 273, the main CPU 274, the first to nth interface 275-1 to 275-n may be connected to each other by the bus 276.

A command set to boot a system may be stored in the ROM 272. When power is provided by a turn on command is input, the main CPU 274 copies an O/S stored in the storage 240 according to a command stored in the ROM 272 and boots a system by operating the 0/S. When the system is completely booted, the main CPU 274 copies various application programs in the RAM 271 stored in the storage 240, and performs various operations by implementing the copied application programs.

The graphic processor 273 generates a screen including various objects such as a pointer, an icon, an image and a text by using a calculating unit (not illustrated) and a rendering unit (not illustrated). The calculating unit calculates an attribute value such as a coordinate value, a form, a size and color(s) by which respective objects are indicated according to a layout of a screen by using a controlling command received from an inputter (not illustrated). The rendering unit generates a screen of various layouts that include an object based on an attribute value calculated in the calculating unit. A screen generated in the rendering unit is displayed in a display area of the image output unit 210.

The main CPU 274 accesses the storage 240 and performs a booting by using an O/S which is stored in the storage 240. The main CPU 274 performs various operations by using various programs, contents and data stored in the storage 240.

A first to nth interface 275-1 to 275-n are connected to the above-described various constituent elements. One of the interfaces may be a network interface which is connected to an external device through network.

According to an exemplary embodiment, the controller 270 acquires an image through the image acquiring unit 260. The controller 270 extracts a search formula from the acquired image and generates a search result based on the extracted search formula. The controller 270 controls the image output unit 210 to output a generated search result.

According to an exemplary embodiment, the controller 270 may control the image acquiring unit 260 to acquire an image that includes a search formula. The image may be acquired through the image acquiring unit 270, and/or the image may be received from an external device through the communicator 230.

The controller 270 may extract a search formula from the acquired image.

According to an exemplary embodiment, the controller 270 may extract a search identifier which is included in the acquired image. Since a search identifier may be indicated as an underline or a shade setting, the controller 270 may extract an underline or a shade setting that is included in an image as a search identifier. The controller 270 may extract a letter, a character and a figure which are written with an invisible pen as a search identifier.

When a search identifier is extracted, the controller 270 may extract a search formula corresponding to the search identifier. According to an exemplary embodiment, if a search identifier is an underline, the controller 270 may recognize a letter which is underlined as a search word and extract a letter(s) written under the underline as a search formula. Herein, the search formula may include at least one of a search domain, a search command and a search result outputting device. In case that the search formula includes two or more than two among the search domain, the search command and the search result outputting device, the controller 270 may classify the search domain, the search command and the search result outputting device through “,” or “:” between the search domain, the search command and the search result outputting device. The search domain may indicate an Internet web-page or a search server to search for a search word, the search command may indicate a search performance and the search result outputting device may indicate a device to output a search result.

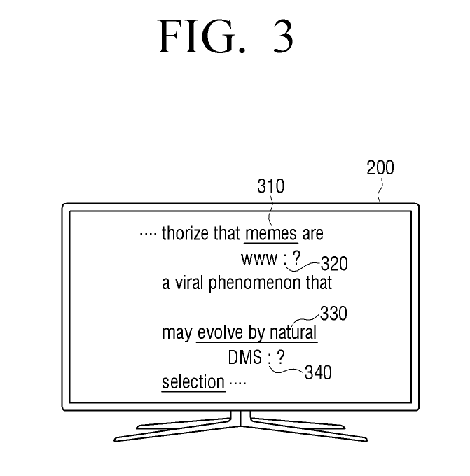

For example, as illustrated in FIG. 3, if an image including a search formula is acquired through the image acquiring unit 260, the controller 270 may extract an underline (for example, “______”) as a search identifier. If an underline is extracted as a search identifier, the controller 270 may recognize a letter “meme” 310 and “evolve by natural selection” 330 which are underlined as search words and extract “www:?(320)” and “DMS:?(340)” which are written under the underlines as search formulas. The controller 270 may output a search result by searching for the search word “meme” 310 on an Internet web-page based on the extracted search formula “www:?(320),” and may output a search result by searching for the search word “evolve by natural selection” 330 based on the search formula “DMS:?(340)” in a data management system (DMS).

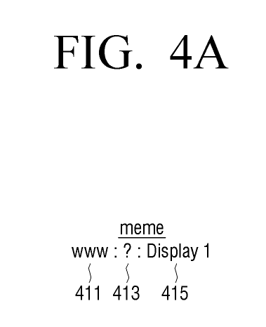

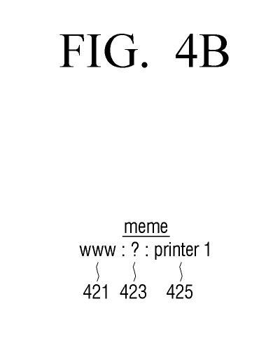

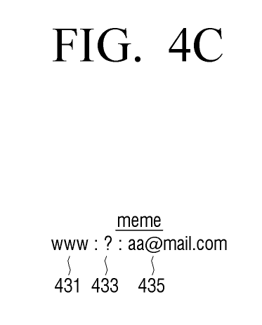

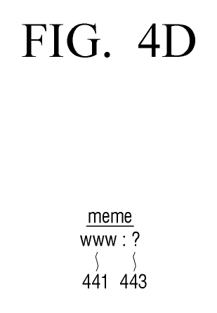

FIGS. 4A to 4D illustrate an exemplary search formula. The controller 270 may extract a letter written under and near an underline or a shade setting as a search identifier. The search formula may include at least one of a search domain, a search command and a search result outputting device. According to an exemplary embodiment, a search formula may be a form such as “search domain 1, search domain 2:a search command:a search result outputting device.”

For example, the search formula “www(411):?(413):Display1(415)” illustrated in FIG. 4A may be a search formula that includes “www” 411 indicating a search domain, “?” 413 indicating a search command and “Display1” 415 indicating a search result outputting device. The search domain “www” 411 which indicates an web-page or a search server to search for a search word may indicate to search for a search word by using an Internet web-page. The search command “?” 413 that indicates a performance command designation may indicate to perform a search. “Display1” 415 that designates a search result outputting device may indicate to output a search result to Display1 (415). In other words, the search formula “www(411):?(413):Display1(415)” is a search formula to output a search result from the search word “meme” which is searched on the Internet web-page on Display1 415.

For example of another exemplary embodiment, the search formula “www(421):?(423):printer1(425)” illustrated in FIG. 4B may be a search formula that includes “www” 421 that indicates a search domain, “?” 423 that indicates a search command and “printer1” 425 that indicates a search result outputting device. The search domain “www” 421 indicating an web-page or a search server to search for a search word may indicate to search for a search word by using an Internet web-page. The search command “?” 423 indicating a performance command designation may indicate to perform a search. “printer1” 425 designating a search result outputting device may indicate to output a search result through printer1 425. In other words, the search formula “www(421):?(423):printer1(425)” is a search formula to output a search result from the search word “meme” which is searched on the Internet web-page through printer1 425.

For example of another exemplary embodiment, the search formula “www(431):?(433):aa@mail.com(435)” illustrated in FIG. 4C may be a search formula that includes “www” 431 indicating a search domain, “?” 433 indicating a search command and “aa@mail.com” 435 indicating a search result outputting device. The search domain “www” 431 that indicates an web-page or a search server to search for a search word may indicate to search a search word by using an Internet web-page. The search command “?” 433 indicating a performance command designation may indicate to perform a search. “aa@mail.com” 435 designating a search result outputting device may indicate to output a search result to “aa@mail.com” 435. In other words, the search formula “www(431):?(433):aa@mail.com(435)” is a search formula to output a search result from the search word “meme” which is searched on the Internet web-page to “aa@mail.com” 435.

For example of another exemplary embodiment, the search formula “www(441):?(443)” illustrated in FIG. 4D may be a search formula that includes “www” 441 indicating a search domain and “?” 443 indicating a search command. The search domain “www” 441 indicating an web-page or a search server to search for a search word may indicate to search for a search word by using an Internet web-page. The search command “?” 443 indicating a performance command designation may indicate to perform a search. That a search result outputting device for designating a search result outputting device is not included may indicate to output a search result on the image output unit 210 of the electronic device 200. In other words, the search formula “www(441):?(443)” is a search formula to output a search result from the search word “meme” being searched on the Internet web-page on the image outputting unit 210. Including one search domain, one search command and one search result outputting device only pertaining to an exemplary embodiment, and a plurality of search domains, search commands and search result outputting devices may be designated. When a search domain is not included or designated as “ALL,” the controller 270 may perform a search on all search domains. When a search result outputting device is not included in a search formula, the controller 270 may control the image outputting unit 210 to output a search result.

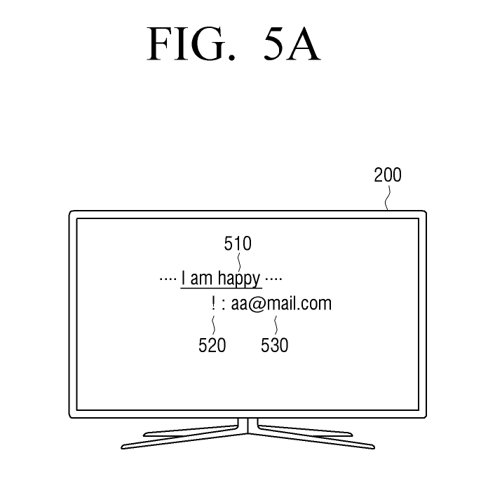

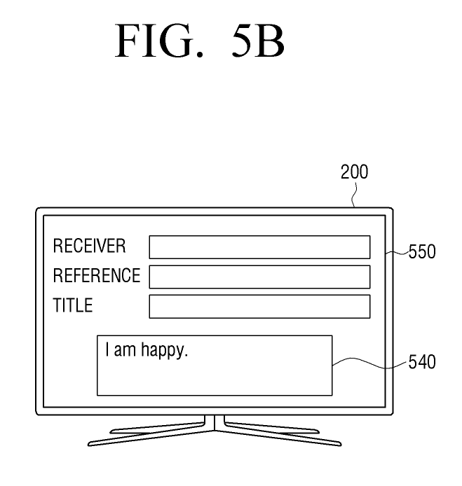

According to another exemplary embodiment, as illustrated in FIGS. 5A and 5B, the controller 270 not only may search but also may copy. For example, when “I am happy” 510 and the search formula “!(520):aa@mail.com(530)” are extracted, the controller 270 may copy “I am happy” 510 according to the search command “!” 520. As illustrated in FIG. 5B, the controller 270 may enables pasting the copied sentence (or a phrase) “I am happy” 510 in a content part 540 of “aa@mail.com” 550. A user may be able to copy “I am happy” 510 which is written on an offline document and paste in an e-mail without process of inputting the sentence in an electronic device.

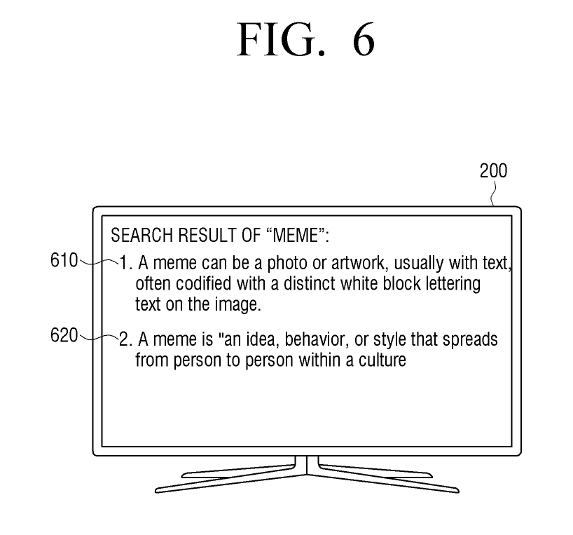

The controller 270 may generate a search result based on peripheral context of an extracted search formula and a search word. According to an exemplary embodiment, if there are a plurality of search results of a search word, the controller 270, in order to generate a search result corresponding to the search word, may output the search result based on context of peripheral sentences and a sentence including the search word. For example, as illustrated in FIG. 6, when a search word “meme” was searched on an Internet web-page based on the search formula “www(630):?(640):printer1(650),” “1. A meme can be a photo or artwork, usually with text, often codified with a distinct white block lettering text on the image” 610 and “2. A meme may be defined as “an idea, behavior, or style that spreads from person to person within a culture” 620 may be searched. The controller 270 may generate “2. A meme is “an idea, behavior, or style that spreads from person to person within a culture” 620 as a search result based on context of the sentence “theorize that memes are a viral phenomenon that may evolve by natural selection” where the search word “meme” is included. In addition to context of a sentence including a search word, the controller 270 may generate a search result based on context of a previous sentence or a next sentence of a sentence including the search word. Accordingly, when a plurality of results are output through a search, inconvenience of an additional search may be reduced for a user.

The controller 270 may output a search result. According to an exemplary embodiment, when the electronic device 200 directly outputs a search result, the controller 270 may control the image output unit 210 or the audio output unit 220 to output the search result. When a search result is output through an external device, the controller 270 may control the communicator 230 to transmit the search result.

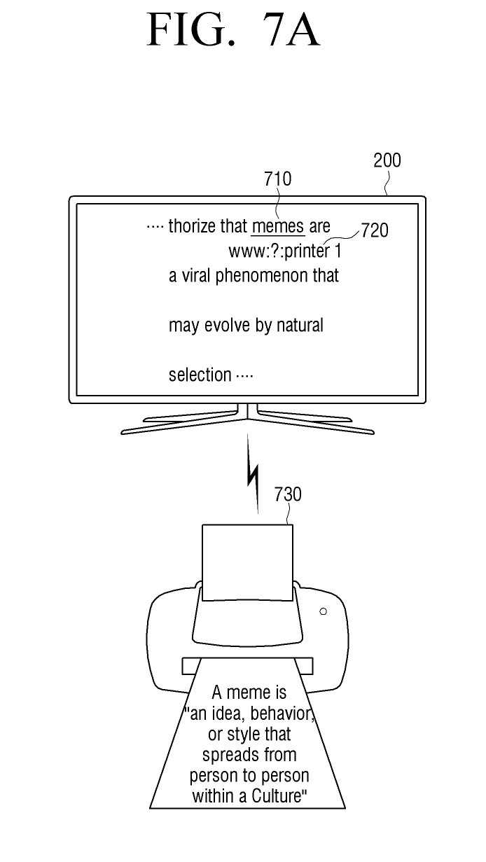

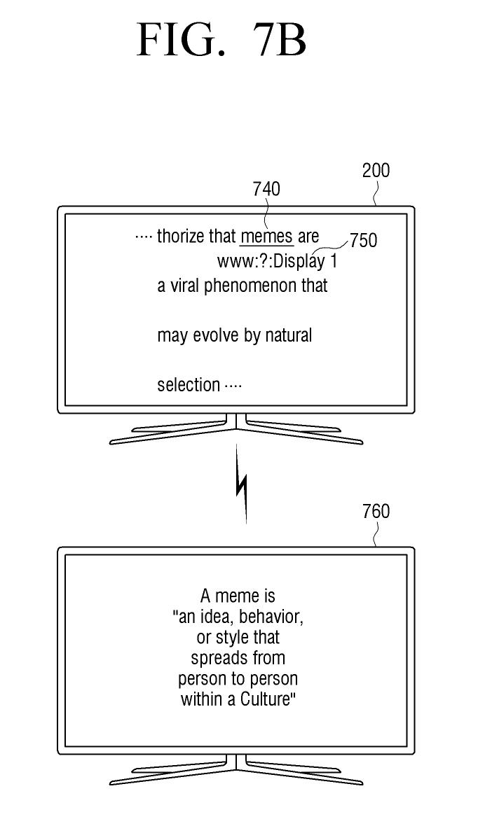

For example, as illustrated in FIG. 7A, the controller 270 may search a search word “meme” 710 by using an Internet web-page based on the search formula “www:?:printer1(720).” The controller 270 may control the communicator 230 to send a search result of “meme” 710 to printer1 730. For example of another exemplary embodiment, as illustrated in FIG. 7B, the controller 270 may search the search word “meme” 740 based on the search formula “www:?:Display1(750)” by using an Internet web-page. The controller 270 may control the communicator 230 to send a search result from “meme” 740 to Display1 760.

When a search result outputting device is not designated, the controller 270 may control the image output unit 210 to output a search result. For example, when a search word is searched based on the search formula “www:?,” the controller 270 may control the image output unit 210 to output a search result.

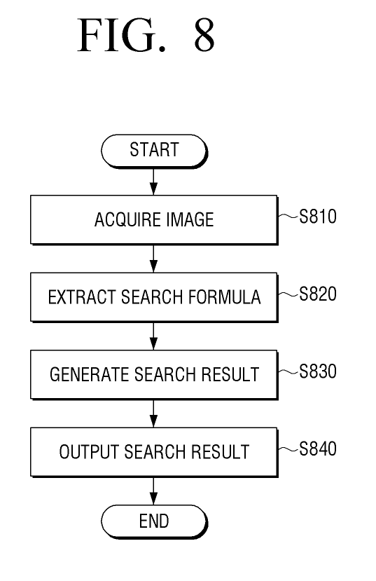

Hereinafter, controlling method of the electronic device 100 according to an exemplary embodiment with reference to FIG. 8 is described.

The electronic device 100 acquires an image where a search formula is included (S810).

Then the electronic device 100 extracts a search formula from the extracted image (S820).

According to an exemplary embodiment, the electronic device 100 may recognize a character which is included in acquired image by using an optical character reader or intelligent character recognition. The electronic device 100 may recognize a search identifier and extract a search formula corresponding to the recognized search identifier. The search identifier may be at least one of an underline and a shade setting, and the search formula may include at least one of a search domain, a search command and a search result outputting device.

The electronic device 100 may generate a search result based on the extracted search formula (S830). According to an exemplary embodiment, the electronic device 100 may generate a search result by searching a search word in a search domain.

Also, the electronic device 100 extracts the generated search result (S840). The electronic device 100 may directly output the generated search result or output the generated search result through an external device.

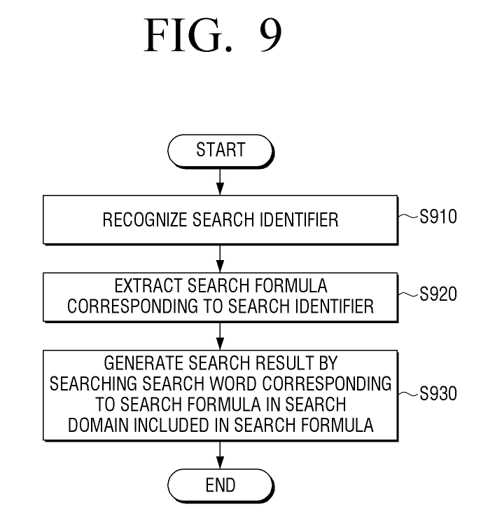

Hereinafter, a method of generating a search result of the electronic device 100 according to an exemplary embodiment is described in detail with reference to FIG. 9.

The electronic device 100 recognizes a search identifier from an acquired image (S910). The electronic device 100 may recognize an underline or a shade setting included in the acquired image as a search identifier. The search identifier is marked by a user and is to designate a character that the user wants to search. Or, the electronic device 100 may recognize a letter, a character, a figure which is written with an invisible pen as a search identifier. The electronic device 100 may determine a character marked by a search identifier as a search word.

The electronic device 100 extracts a search formula corresponding to the recognized search identifier (S920). The electronic device 100 may extract a letter or a character indicated by a user under the search identifier as a search formula. A search formula being indicated under the search identifier only pertains to an exemplary embodiment and a search formula may be indicated wherever near a search identifier.

The electronic device 100 generates a search result by searching a search word in a search domain corresponding to a search formula (S930). The electronic device 100 may generate a search result by selecting one among a plurality of search results based on context of a sentence including a search word in addition to a search result from a search word that is searched on a search domain.

According to the above-described various exemplary embodiments, a user may search online without inconvenience of inputting an offline material online.

According to an exemplary embodiment, a method may be programmed to be carried out in a computer and may be embodied in a general-purpose digital computer which operates the program by using a computer-readable recording medium. Data structure used in the above-described method may be recorded in a computer-readable recording medium. The computer-readable recording media include storage media such as magnetic storage media (for example, a ROM, a floppy disk and a hard disk) and optical readable media (for example, a CD-ROM and a DVD).

It will be understood by those skilled in the art that various changes in form and details can be made therein without departing from the spirit and scope of the invention as defined by the appended claims. Therefore, the description of the exemplary embodiments of the present disclosure is intended to be illustrative, and not to limit the scope of the claims. The scope of the present disclose is indicated not in the above description but in claims, and all differences within a scope equivalent to the scope should be understood as included in the present disclosure.

What is claimed is:

1. A controlling method of an electronic device, comprising:
acquiring an image by the electronic device;
controlling the electronic device to extract a search formula from the acquired image;
generating a search result based on the extracted search formula; and
outputting the generated search result.

2. The method as claimed in claim 1, wherein the search formula comprises at least one of a search domain, a search command and a search result outputting device.

3. The method as claimed in claim 2, wherein the controlling the electronic device to extract the search formula comprises recognizing a search identifier included in the acquired image and extracting a search formula corresponding to the recognized search identifier.

4. The method as claimed in claim 3, wherein the search identifier comprises at least one of an underline and a shade setting.

5. The method as claimed in claim 2, wherein the search domain comprises designating an Internet web-page or a search server to search a search word.

6. The method as claimed in claim 1, wherein the generating a search result comprises generating the search result based on context of a sentence that includes the search word.

7. The method as claimed in claim 1, wherein the controlling the electronic device to extract the search formula comprises recognizing a character included in the image by using an optical character reader and extracting the search formula that is input by a user of the electronic device by using intelligent character recognition.

8. The method as claimed in claim 1, wherein the outputting comprises transmitting the search result to at least one of a printer, a display device and a predesignated Internet address.

9. An electronic device, comprising:
an image acquiring unit configured to acquire an image;
an output unit configured to output a search result; and
a controller including at least one hardware processor and configured to control the image acquiring unit to acquire the image and to control the at least one hardware processor to extract a search formula from the acquired image and to generate a search result by using the extracted search formula, and to control the output unit to output the generated search result.

10. The electronic device as claimed in claim 9, wherein the search formula comprises at least one of a search domain, a search command and a search result outputting device.

11. The electronic device as claimed in claim 10, wherein the controller configured to control the at least one hardware processor to recognize a search identifier included in the acquired image and to extract the search formula corresponding to the recognized search identifier.

12. The electronic device as claimed in claim 11, wherein the search identifier comprises at least one of an underline and a shade setting.

13. The electronic device as claimed in claim 10, wherein the search domain comprises designating an Internet web-page or a search server to search a search word.

14. The electronic device as claimed in claim 9, wherein the controller configured to control the at least one hardware processor to generate the search result based on context of a sentence that includes the search word.

15. The electronic device as claimed in claim 9, wherein the controller configured to control the at least one hardware processor to recognize a character included in the image by using an optical character reader and extracting a search formula which is input by a user by using intelligent character recognition.

16. The electronic device as claimed in claim 9, further comprising:
a communicator configured to communicate with an external device,
wherein the controller configured to control the communicator to transmit the search result to at least one of a printer, a display device and a predesignated Internet address.
